(19) United States
(12) Patent Application Publication
(10) Pub. No.: US 2022/0353398 A1
(43) Pub. Date: Nov. 3, 2022

(54) FIXING STRUCTURE AND ELECTRONIC APPARATUS

(71) Applicant: SHARP KABUSHIKI KAISHA, Osaka (JP)

(72) Inventor: YOSHIO HASHIWATA, Osaka (JP)

(21) Appl. No.: 17/718,707

(22) Filed: Apr. 12, 2022

(30) Foreign Application Priority Data
Apr. 28, 2021 (JP) 2021-076765

(51) Int. Cl. H04N 5/225; G02B 5/00

(52) U.S. Cl. CPC H04N 5/22521; G02B 5/003; H04N 5/2253; H04N 5/2256

(57) ABSTRACT

A fixing structure for fixing, within a housing of an electronic apparatus, a light-shielding member that surrounds a periphery of a light-emitting part and that shields light includes a light-transmissive member that comes into contact with the light-shielding member, that protects the light-emitting part, and that transmits light, and an elastic member that is disposed on an opposite side of the light-shielding member from the light-transmissive member and that presses the light-shielding member toward the light-transmissive member.

### BACKGROUND

### 1. Field

The present disclosure relates to a fixing structure and an electronic apparatus.

### 2. Description of the Related Art

Japanese Unexamined Patent Application Publication No. 2012-230427 discloses an aftermarket part which is attached around a portion of a photography device, including a camera and a flash, at which the flash is provided, and which is made of a light-shielding material. Thus, when the photography device is covered with an aftermarket case made of a light-transmissive material, this aftermarket part enables photographed images to be protected from adverse effects of light from the flash transmitted through the aftermarket case and reflected in a lens portion of the camera.

However, in the related art disclosed in Japanese Unexamined Patent Application Publication No. 2012-230427, a through-hole is formed in the aftermarket case, and the camera and the flash of the photography device are exposed from the through-hole in a state in which the photography device is covered by the aftermarket case.

Accordingly, in order to impart waterproof and dustproof functions for the camera and the flash, a part that is separate from the aftermarket case and that is made of a light-transmissive material has to be disposed over the through-hole of the aftermarket case. In this case, leakage of light occurs through a gap between this part and the aftermarket case, and accordingly light-shielding tape for filling in this gap has to be disposed thereat. Further, a printed layer has to be disposed on the part to conceal the light-shielding tape.

It is desirable to shield light traveling in a lateral direction from a gap between a light-transmissive member that protects an electronic part for image capturing and a light-shielding member.

### SUMMARY

A fixing structure according to an aspect of the present disclosure is a fixing structure for fixing, within a housing of an electronic apparatus, a light-shielding member that surrounds a periphery of an electronic part for image capturing and that shields light. The fixing structure includes a light-transmissive member that comes into contact with the light-shielding member, that protects the electronic part for image capturing, and that transmits light, and an elastic member that is disposed on an opposite side of the light-shielding member from the light-transmissive member and that presses the light-shielding member toward the light-transmissive member.

### BRIEF DESCRIPTION OF THE DRAWINGS

FIG. 1 is a rear view illustrating part of an electronic apparatus according to a first embodiment of the present disclosure;

FIG. 2 is an arrow sectional view taken along line II-II of the electronic apparatus illustrated in FIG. 1;

FIG. 3 is an enlarged sectional view of a portion of the electronic apparatus illustrated in FIG. 2 that is encircled by a dashed line;

FIG. 4 is a diagram illustrating a configuration of a comparative example for comparison with a configuration of part of the electronic apparatus illustrated in FIG. 3; and

FIG. 5 is a sectional view illustrating a configuration of part of an electronic apparatus according to a second embodiment of the present disclosure.

### DESCRIPTION OF THE EMBODIMENTS

### First Embodiment

### Configuration of Electronic Apparatus 1

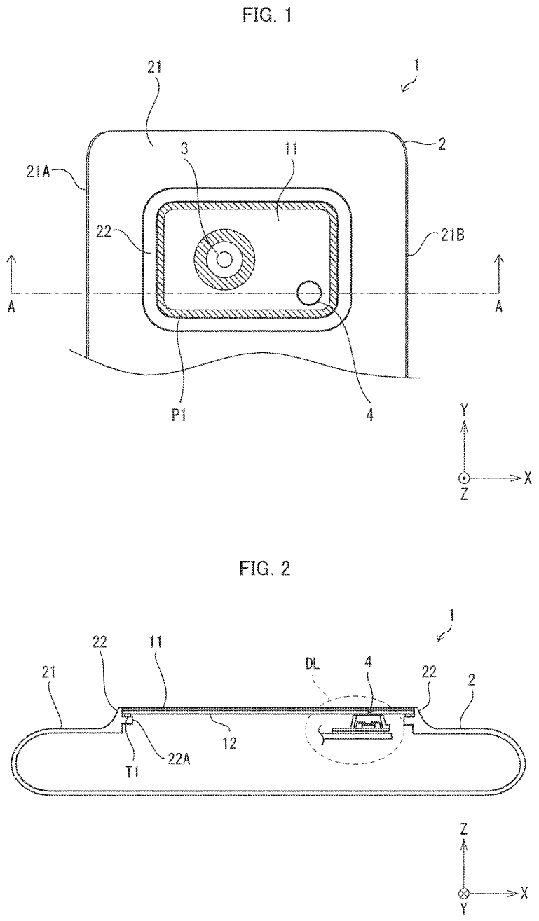

FIG. 1 is a rear view illustrating part of an electronic apparatus 1 according to a first embodiment of the present disclosure. FIG. 2 is an arrow sectional view taken along line II-II of the electronic apparatus 1 illustrated in FIG. 1. Note that configurations other than a housing 2, a flash unit 4, a light-transmissive member 11, a scatterproofing film 12, and double-sided tape T1 are omitted in FIG. 2. Also, in FIGS. 1 and 2, a direction from a left end 21A of a rear surface 21 of the housing 2 toward a right end 21B thereof is an X-axis direction, a direction from the flash unit 4 toward the light-transmissive member 11 is a Z-axis direction, and a direction orthogonal to both the X-axis direction and the Z-axis direction is a Y-axis direction.

As illustrated in FIG. 1, the electronic apparatus 1 includes the housing 2, a camera 3, and the flash unit 4. The electronic apparatus 1 is a smartphone, but is not limited thereto. For example, the electronic apparatus 1 may be a tablet or a personal computer (PC). A display panel (not illustrated) is disposed on a front side of the housing 2.

The camera 3 and the flash unit 4 are disposed in the rear surface 21. The light-transmissive member 11 is disposed on the rear surface 21 so as to cover the camera 3 and the flash unit 4. The light-transmissive member 11 is formed of, for example, a light-transmissive resin or glass that transmits light. The light-transmissive member 11 is for imparting waterproof and dustproof functions for the camera 3 and the flash unit 4.

As illustrated in FIG. 2, the scatterproofing film 12 is attached to the light-transmissive member 11, on the Z-axis negative-direction side thereof. The scatterproofing film 12 includes a base material made of acrylic, polyester, or polyethylene and is surface-treated by water-repellent finishing with a fluorocarbon or the like.

The housing 2 has an attachment portion 22A where a rear surface of a peripheral edge of the scatterproofing film 12 is attached with the double-sided tape T1. A frame portion 22 that is substantially rectangular and that covers a side surface of a peripheral edge of the light-transmissive member 11 is formed on the rear surface 21, surrounding the attachment portion 22A.

The camera 3 captures still images and moving images. The flash unit 4 emits light. The flash unit 4 will be described in detail later. As illustrated in FIG. 1, a printed layer P1 is disposed around the periphery of the camera 3 and is also disposed along the inner periphery of the frame portion 22. The hatched portions illustrated in FIG. 1 indicate the printed layer P1.

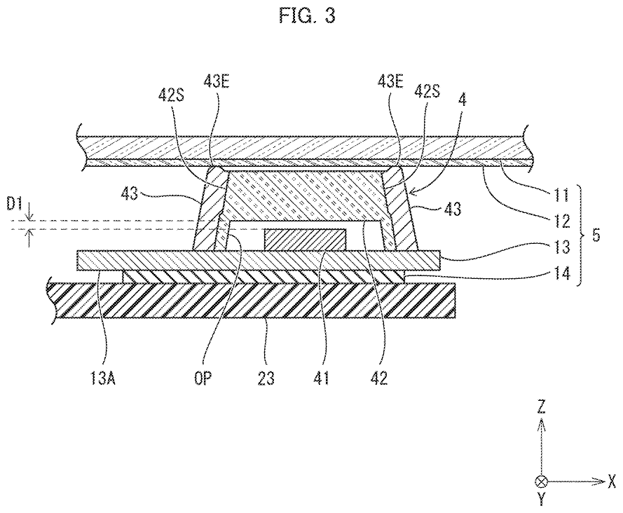

FIG. 3 is an enlarged sectional view of a portion of the electronic apparatus 1 illustrated in FIG. 2 that is encircled by a dashed line DL. The electronic apparatus 1 includes a fixing structure 5 for fixing a light-shielding member 43 within the housing 2 of the electronic apparatus 1. As illustrated in FIG. 3, the fixing structure 5 includes the light-transmissive member 11, the scatterproofing film 12, a substrate 13, and an elastic member 14. The flash unit 4 includes a light-emitting part 41, a window member 42, and the light-shielding member 43.

The light-transmissive member 11 comes into contact with the light-shielding member 43 from the Z-axis positive-direction side thereof to protect the light-emitting part 41 while transmitting light. The light-emitting part 41, the window member 42, and the light-shielding member 43 may be provided on the substrate 13. The substrate 13 may be for supporting the members of the flash unit 4.

The elastic member 14 is disposed on the opposite side of the light-shielding member 43 from the light-transmissive member 11, and presses the light-shielding member 43 toward the light-transmissive member 11. Specifically, the elastic member 14 may be connected to the substrate 13 and press the substrate 13 toward the light-transmissive member 11. The elastic member 14 is, for example, a cushioning member; however, the elastic member 14 is not limited thereto, but may be a leaf spring, silicon rubber, polyurethane rubber, fluorocarbon rubber, or the like. The elastic member 14 is disposed on a frame 23. The frame 23 is formed integrally with an exterior of the housing 2, and is formed on the inside of the housing 2. Note that the elastic member 14 may be provided on another part housed within the housing 2 of the electronic apparatus 1.

The elastic member 14 is partially connected to a back surface 13A of the substrate 13, on the Z-axis negative-direction side thereof. That is to say, an area of a contact surface between the elastic member 14 and the back surface 13A is smaller than an entire area of the back surface 13A. Accordingly, the size of the elastic member 14 can be reduced as compared to a case in which the elastic member 14 is connected to the entire back surface 13A, and manufacturing costs of the electronic apparatus 1 can be reduced.

However, the elastic member 14 is not limited to the above configuration, but may be connected to the entire back surface 13A. That is to say, the area of the contact surface between the elastic member 14 and the back surface 13A may be the same as the entire area of the back surface 13A. Thus, when an item obtained by attaching the elastic member 14 to the substrate 13 is fabricated as a single part, for example, the outer shape of the item obtained by attaching the elastic member 14 to the substrate 13 can be processed in a single step. Accordingly, manufacturing costs of the electronic apparatus 1 can be reduced, since processing of the outer shape of the substrate 13 and processing of the outer shape of the elastic member 14 do not have to be performed in separate steps. This is particularly effective in a case in which the size of the substrate 13 is small.

The light-emitting part 41 is an electronic part for image capturing that emits light toward the light-transmissive member 11. The term “electronic part for image capturing” means an electronic part that is used for image capturing by the camera 3. An example of the electronic part for image capturing may be, besides the light-emitting part 41 of the flash unit 4, an image-capturing element that the camera 3 includes. That is to say, an aspect of the present disclosure may be applied to a fixing structure 5 for fixing a light-shielding member 43 that surrounds the periphery of an electronic part for image capturing other than the light-emitting part 41 and that shields light. The light-emitting part 41 is, for example, a light-emitting diode (LED).

The window member 42 is formed of, for example, a light-transmissive resin that transmits light from the light-emitting part 41. An opening portion OP is formed in the window member 42, on the Z-axis negative-direction side thereof. A space formed between the light-emitting part 41 and the opening portion OP is covered by the window member 42. Forming the opening portion OP in the window member 42 creates a distance D1 between the light-emitting part 41 and the window member 42. The distance D1 is a distance in the Z-axis direction.

The light-shielding member 43 surrounds the periphery of the light-emitting part 41, and shields light emitted from the light-emitting part 41. The light-shielding member 43 is a colored member that is colored in its entirety, and is in contact with an outer peripheral surface 42S of the window member 42. Accordingly, the outer periphery of the window member 42 is colored by the light-shielding member 43 when the flash unit 4 is viewed in the negative direction of the Z-axis. Note that the light-shielding member 43 may be partially colored. In this case, the surface of the light-shielding member 43 that faces the window member 42 is colored.

An end portion 43E of the light-shielding member 43 on the Z-axis positive-direction side thereof has a protruding shape. Thus, the light-shielding member 43 and the light-transmissive member 11 are in line contact, and accordingly light traveling in the lateral direction from a gap between the light-transmissive member 11 and the light-shielding member 43 can be efficiently shielded. The end portion 43E is a portion of the light-shielding member 43 that faces the light-transmissive member 11.

Also, a gap is formed between the light-transmissive member 11 and the window member 42. More precisely, a gap is formed between the scatterproofing film 12 and the window member 42. Accordingly, the scatterproofing film 12 and the window member 42 do not come into contact, and therefore the light-shielding member 43 and the light-transmissive member 11 can be brought into line contact. Further, this enables the electronic apparatus 1 to be assembled while tolerating dimensional errors or the like of the members of the electronic apparatus 1, and also prevents any shock applied to the light-transmissive member 11 from being directly transmitted to the window member 42.

As described above, according to the configuration of the fixing structure 5, the light-shielding member 43 is pressed toward the light-transmissive member 11 by the elastic member 14, whereby the gap between the light-transmissive member 11 and the light-shielding member 43 can be sealed off. Accordingly, light traveling in the lateral direction from the gap between the light-transmissive member 11 and the light-shielding member 43 can be shielded.

Also, the substrate 13 on which the light-shielding member 43 is disposed is pressed toward the light-transmissive member 11 by the elastic member 14. Accordingly, pressure is uniformly applied to the entire light-shielding member 43 from the substrate 13, and thus the portion of the light-shielding member 43 in contact with the light-transmissive member 11 can be uniformly pressed against the light-transmissive member 11. Hence, the gap between the light-transmissive member 11 and the light-shielding member 43 can be efficiently sealed off.

Further, because the substrate 13 on which the light-shielding member 43 is disposed is pressed toward the light-transmissive member 11 by the elastic member 14, the distance D1 between the light-emitting part 41 and the window member 42 becomes stable. Accordingly, effects on light-emission performance of the flash unit 4 due to the distance D1 becoming unstable can be reduced.

Moreover, leakage of light emitted from the light-emitting part 41 through the gap between the light-transmissive member 11 and the light-shielding member 43 can be reduced by the light-shielding member 43 being pressed toward the light-transmissive member 11 by the elastic member 14.

### Configuration of Comparative Example

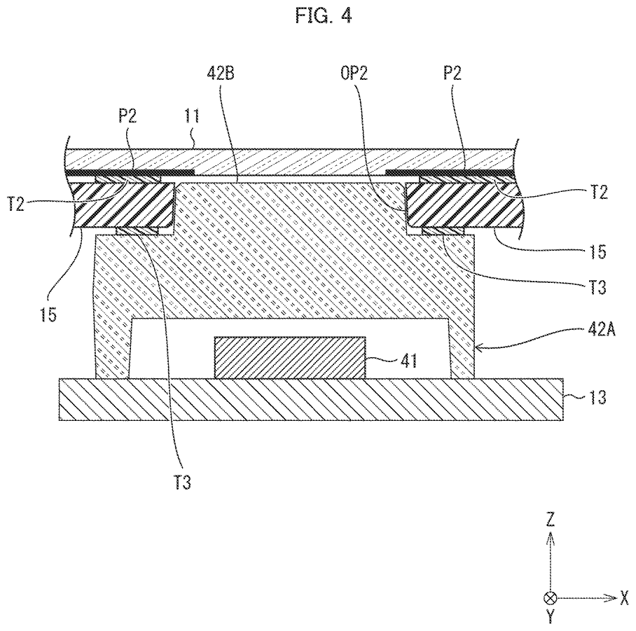

FIG. 4 is a diagram illustrating the configuration of a comparative example for comparison with a configuration of part of the electronic apparatus 1 illustrated in FIG. 3. As illustrated in FIG. 4, in the comparative example, the electronic apparatus does not include the elastic member 14 or the light-shielding member 43. A cover 15 is disposed between the light-transmissive member 11 and a window member 42A. An opening portion OP2 is formed in the cover 15, and a protruding portion 42B of the window member 42A is fitted into the opening portion OP2.

The light-transmissive member 11 and the cover 15 are fixed with double-sided tape T2, and the cover 15 and the window member 42A are fixed with double-sided tape T3. Also, a printed layer P2 is provided on the light-transmissive member 11, on the Z-axis negative-direction side thereof, so that the double-sided tape T2 is not visible from the outside of the electronic apparatus according to the comparative example. The printed layer P2 covers the double-sided tape T2. The double-sided tape T2 is for shielding light traveling in the lateral direction from a gap between the light-transmissive member 11 and the cover 15.

As described above, the electronic apparatus according to the comparative example does not have the elastic member 14 or the light-shielding member 43, and accordingly the printed layer P2 has to be disposed on the light-transmissive member 11, to cover the double-sided tape T2. Conversely, the light-shielding member 43 is pressed toward the light-transmissive member 11 by the elastic member 14 in the electronic apparatus 1, whereby light traveling in the lateral direction from the gap between the light-transmissive member 11 and the light-shielding member 43 can be shielded without double-sided tape. Also, as illustrated in FIG. 1, the printed layer P1 does not have to be provided on the light-transmissive member 11 at the periphery of the flash unit 4, and accordingly the degree of freedom in design of the electronic apparatus 1 can be improved.

### Second Embodiment

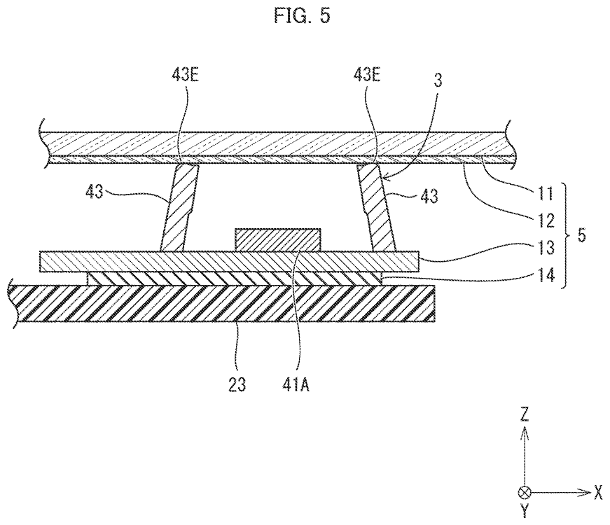

A second embodiment of the present disclosure will be described below. Note that for the sake of convenience of description, members having the same functions as the members described in the first embodiment are denoted by the same symbols, and description thereof will not be repeated. FIG. 5 is a sectional view illustrating a configuration of part of an electronic apparatus according to the second embodiment of the present disclosure. The configuration illustrated in FIG. 5 differs from the configuration illustrated in FIG. 3 in that no window member 42 is included, and the light-emitting part 41 is replaced by an image-capturing element 41A.

A configuration of the camera 3 included in the electronic apparatus according to the second embodiment may be the configuration illustrated in FIG. 5. The camera 3 includes the image-capturing element 41A and the light-shielding member 43. Although the camera 3 has other parts besides the image-capturing element 41A and the light-shielding member 43, such as lenses and so forth, these other parts are not illustrated.

The light-transmissive member 11 protects the image-capturing element 41A. The image-capturing element 41A is disposed on the substrate 13. The image-capturing element 41A is an electronic part for image capturing that receives light passing through the light-transmissive member 11. Examples of the image-capturing element 41A include a charge-coupled device (CCD) image sensor and a complementary metal-oxide semiconductor (CMOS) image sensor. The light-shielding member 43 surrounds a periphery of the image-capturing element 41A, and shields light traveling toward the image-capturing element 41A from the gap between the light-transmissive member 11 and the light-shielding member 43.

The gap between the light-transmissive member 11 and the light-shielding member 43 is sealed off by the light-shielding member 43 being pressed toward the light-transmissive member 11 by the elastic member 14. Accordingly, incoming light traveling from this gap toward the image-capturing element 41A can be reduced, and thus the effects on images captured by the image-capturing element 41A can be reduced.

### Summarization

A fixing structure according to Form 1 of the present disclosure is a fixing structure for fixing, within a housing of an electronic apparatus, a light-shielding member that surrounds a periphery of an electronic part for image capturing and that shields light. The fixing structure includes a light-transmissive member that comes into contact with the light-shielding member, that protects the electronic part for image capturing, and that transmits light, and an elastic member that is disposed on an opposite side of the light-shielding member from the light-transmissive member, and that presses the light-shielding member toward the light-transmissive member.

In Form 1 above, a fixing structure according to Form 2 of the present disclosure may further include a substrate on which the electronic part for image capturing and the light-shielding member are disposed. The elastic member may be connected to the substrate and may press the substrate toward the light-transmissive member.

In a fixing structure according to Form 3 of the present disclosure, in Form 1 or 2 above, the electronic part for image capturing may be a light-emitting part that emits light toward the light-transmissive member.

In a fixing structure according to Form 4 of the present disclosure, in Form 1 or 2 above, the electronic part for image capturing may be an image-capturing element that receives light passing through the light-transmissive member.

An electronic apparatus according to Form 5 of the present disclosure may include the fixing structure according to any one of Forms 1 to 4 above, an electronic part for image capturing, and a light-shielding member.

The present disclosure is not limited to the above-described embodiments; rather, various modifications can be made within the scope set forth in the Claims, and embodiments obtained by appropriately combining technical features disclosed in different embodiments are also encompassed by the technical scope of the present disclosure. Further, new technical features can be formed by combining technical features disclosed in the embodiments.

The present disclosure contains subject matter related to that disclosed in Japanese Priority Patent Application JP 2021-076765 filed in the Japan Patent Office on Apr. 28, 2021, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A fixing structure for fixing, within a housing of an electronic apparatus, a light-shielding member that surrounds a periphery of an electronic part for image capturing and that shields light, the fixing structure comprising:
a light-transmissive member that comes into contact with the light-shielding member, that protects the electronic part for image capturing, and that transmits light; and
an elastic member that is disposed on an opposite side of the light-shielding member from the light-transmissive member and that presses the light-shielding member toward the light-transmissive member.

2. The fixing structure according to claim 1, further comprising:
a substrate on which the electronic part for image capturing and the light-shielding member are disposed,
wherein the elastic member is connected to the substrate and presses the substrate toward the light-transmissive member.

3. The fixing structure according to claim 1, wherein the electronic part for image capturing is a light-emitting part that emits light toward the light-transmissive member.

4. The fixing structure according to claim 1, wherein the electronic part for image capturing is an image-capturing element that receives light passing through the light-transmissive member.

5. An electronic apparatus, comprising:
the fixing structure according to claim 1;
an electronic part for image capturing; and
a light-shielding member.
